(19) United States
(12) Patent Application Publication
(10) Pub. No.: US 2011/0142241 A1
(43) Pub. Date: Jun. 16, 2011

(54) COMMUNICATION APPARATUS CONFIGURED TO PERFORM ENCRYPTED COMMUNICATION AND METHOD AND PROGRAM FOR CONTROLLING THE SAME

(75) Inventor: Fumihide Goto, Naka-gun (JP)

(73) Assignee: CANON KABUSHIKI KAISHA, Tokyo (JP)

(21) Appl. No.: 12/960,223

(22) Filed: Dec. 3, 2010

(30) Foreign Application Priority Data
Dec. 14, 2009 (JP) 2009-283466

(51) Int. Cl. H04L 9/08

(52) U.S. Cl. 380/279

(57) ABSTRACT

In a communication apparatus, a storage device stores encryption keys for encrypted communication with another communication apparatus on a network. A determination is made based on a storage state of encryption keys stored in the storage device whether to provide first encryption key information and second encryption key information wherein the first encryption key information is for encrypted communication using a common encryption key among all communication apparatuses on a network and the second encryption key information is for encrypted communication using an encryption key different for each communication apparatus on the network. Communication parameters including the first encryption key information and the second encryption key information are provided to an apparatus that request for provision of communication parameters based on the determination.

### BACKGROUND OF THE INVENTION

1. Field of the Invention

The present invention relates to a communication apparatus configured to perform encrypted communication and a method and a program for controlling such a communication apparatus.

2. Description of the Related Art

In wireless communication via a wireless network such as a wireless LAN according to IEEE802.11 series standards (hereinafter referred to simply as a wireless LAN), it is necessary to set many communication parameters before the wireless communication is started. For example, they include an SSID (Service Set Identifier) serving as a network identifier, an authentication method, an encryption method, encryption key information, etc. It is very troublesome for a user to manually set all these communication parameters.

Many methods have been proposed to automatically set communication parameters for a wireless device. In these automatic setting methods, according to a procedure predetermined for wireless devices to be connected to each other, messages are transmitted to provide communication parameters from on wireless device to the other wireless device thereby automatically setting the communication parameters.

Recently, Wi-Fi Alliance, which is an industrial standard establishment alliance, has established WPS (Wi-Fi Protected Setup) standards in terms of setting of communication parameters (see, for example, “Wi-Fi CERTIFIED™ for Wi-Fi Protected Setup™: Easing the User Experience for Home and Small Office Wi-Fi® Networks” (http://www.wi-fi.org/files/kc/20090123_Wi-Fi_Protected_Setup.pdf). The WPS standards define a method of automatically setting communication parameters in an infrastructure mode in which a station (local station) is allowed to perform communication via an access point (base station).

US Application Publication No. 2010/0046394 (Japanese Patent Laid-Open No. 2008-187348) discloses an example of a technique of automatically setting communication parameters in an ad-hoc mode in which communication is performed directly among stations not through an access point.

Wireless communication can be bugged easier than wired communication. Therefore, in wireless communication, it is important to establish a high-security communication channel. IEEE802.11i and WPA (Wi-Fi Protected Access) have been established as standards for the wireless LAN. The WPA standard provides a robust encryption algorithm and provides high security by generating an encryption key for each session in which a communication apparatus participates in a network.

In the infrastructure mode, transmission of data is allowed only via an access point. Each communication apparatus has a common encryption key that is shared only between the communication apparatus and an access point. Use of this encryption key ensures high security in communication. In this mode, the number of encryption keys stored in each communication apparatus is fixed.

On the other hand, in the ad-hoc mode, communication between communication apparatuses is performed directly without passing through an access point. In this mode, therefore, when a communication apparatus performs encrypted communication with another communication apparatus, the communication apparatus uses an encryption key that is set differently for each communication apparatus with which to communicate or uses an encryption key that is common over the entire network. In the case where the encryption key is set differently for each communication apparatus with which to communicate, the number of encryption keys stored in each communication apparatus increases with the number of communication apparatuses located on the network.

However, the number of encryption keys that can be stored is limited to a particular value depending on the specifications of each communication apparatus. For example, some communication apparatuses designed for use in communication in the infrastructure mode are capable of storing only one encryption key for unicast and additional one encryption key for multicast or broadcast. For such communication apparatuses, if the network includes a large number of communication apparatuses, it is impossible to store all necessary encryption keys, and thus there is a possibility that encrypted communication is impossible.

### SUMMARY OF THE INVENTION

In view of the above, the present invention provides a technique to perform encrypted communication in an optimum manner depending on a storage state of encryption keys stored in a communication apparatus.

According to an aspect of the present invention, there is provided a communication apparatus comprising a storage device configured to store encryption keys used in encrypted communication with another communication apparatus on a network, a determination device configured to determine whether to provide a first encryption key information and second encryption key information wherein the first encryption key information is for encrypted communication using a common encryption key among all communication apparatuses on the network and the second encryption key information is for encrypted communication using an encryption key different for each communication apparatus on the network, and a providing device configured to provide communication parameters including the first encryption key information and the second encryption key information to an apparatus that request for provision of communication parameters based on the determination made by the determination device.

According to an aspect of the present invention, there is provided a method of controlling a communication apparatus including a storage device configured to store encryption keys used in encrypted communication with another communication apparatus on a network, comprising determining whether to provide first encryption key information and second encryption key information wherein the first encryption key information is for encrypted communication using a common encryption key among all communication apparatuses on the network and the second encryption key information is for encrypted communication using an encryption key different for each communication apparatus on the network, and providing communication parameters including the first encryption key information and the second encryption key information to an apparatus that request for provision of communication parameters based on the determination.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of a communication apparatus.

FIG. 2 is a block diagram illustrating software functions of a communication apparatus.

FIG. 3 is a diagram illustrating a network configuration according to an embodiment of the present invention.

FIG. 4 is a diagram illustrating sequential processes performed among communication apparatuses according to an embodiment of the present invention.

FIG. 5 is a flow chart illustrating a process performed by a communication apparatus according to an embodiment of the present invention.

FIG. 6 is a flow chart illustrating a process performed by a communication apparatus according to an embodiment of the present invention.

### DESCRIPTION OF THE EMBODIMENTS

The present invention is described in further detail below with reference to embodiments in conjunction with the accompanying drawings. In the embodiments described below, it is assumed by way of example that communication is performed using a wireless LAN system according to the IEEE802.11 series standards. Note that communication may be performed using other wireless communication systems.

### First Embodiment

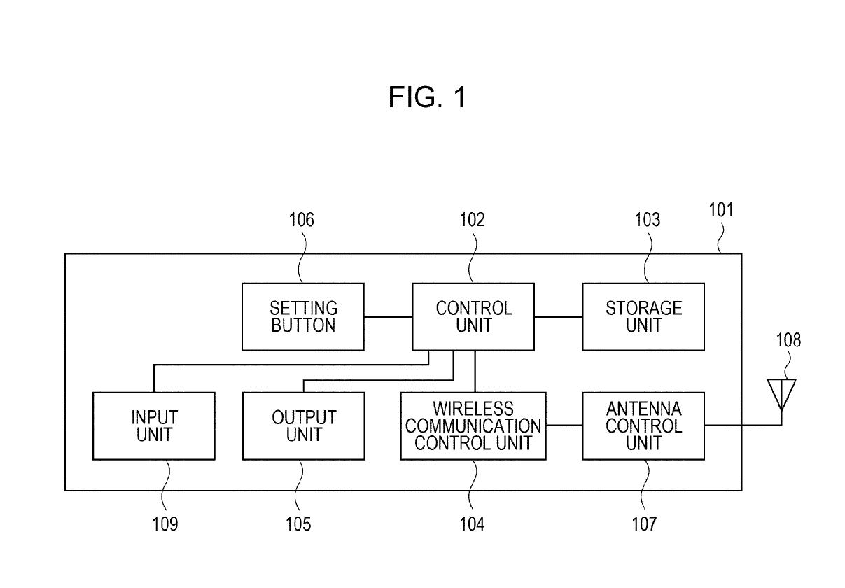

Referring to a block diagram shown in FIG. 1, a hardware configuration of a communication apparatus according to an embodiment of the present invention is described below.

In a communication apparatus 101, a control unit 102 executes a control program stored in a storage unit 103 to control the whole apparatus. The control unit 102 also controls a communication parameter setting process performed between the communication apparatus 101 and another communication apparatus. The storage unit 103 stores the control program executed by the control unit 102 and other various kinds of information including the communication parameters. Operations described below are performed by the control unit 102 by executing the control program stored in the storage unit 103.

A wireless communication control unit 104 controls a wireless LAN communication according to the IEEE802.11 series standards. An output unit 105 outputs various kinds of information. The output unit 105 may be configured to output information in a visible form using an LCD, an LED, or the like or in an audible form using a speaker or the like.

A setting button 106 is used to issue a command to start a communication parameter setting process. If the setting button 106 is operated, the automatic communication parameter setting process is started. Hereinafter, this process will be referred to simply as an automatic setting process. If the control unit 102 detects that the setting button 106 is operated by a user, the control unit 102 performs a process that will be described later.

An antenna control unit 107 controls an antenna 108. An input unit 109 is used by a user to input various kinds of information or commands.

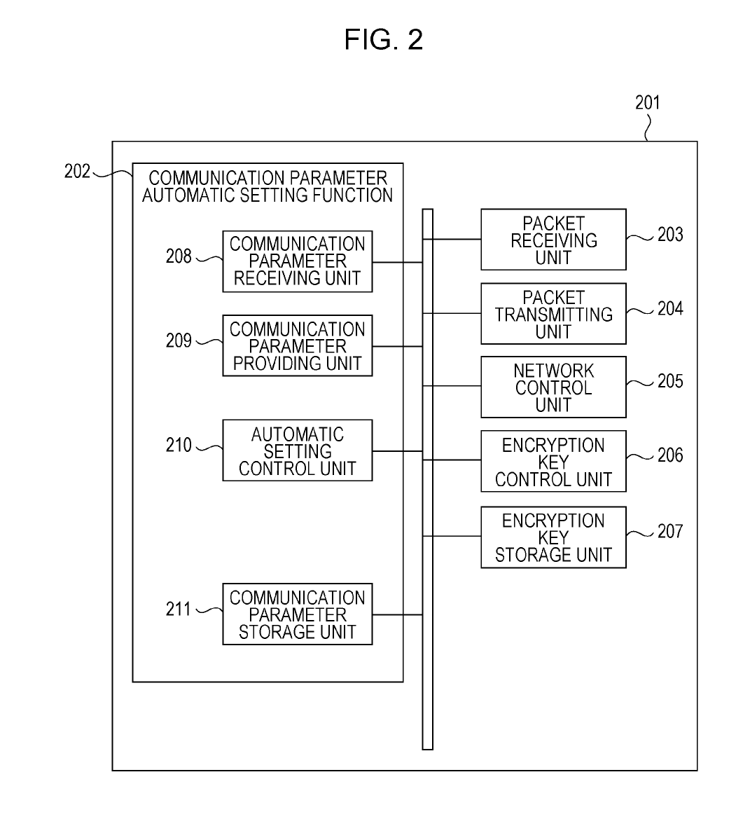

FIG. 2 is a block diagram illustrating an example of a set of software function blocks associated with the process of automatically setting communication parameters, which will be described in detail below.

In FIG. 2, reference numeral 201 denotes the whole apparatus, and reference numeral 202 denotes a communication parameter automatic setting block. In the present embodiment, the communication parameter automatic setting block is configured to automatically set communication parameters necessary in wireless LAN communication, such as an SSID serving as a network identifier, an authentication method, an encryption method, encryption key information, etc.

A packet receiving unit 203 is configured to receive packets in communication. For example, receiving of a beacon (annunciation signal) is performed by the packet receiving unit 203. In addition, receiving of other signals such as a probe request (search signal) and a probe response (a response signal to the probe request) is also performed by the packet receiving unit 203. A packet transmitting unit 204 is configured to transmit packets in communication. More specifically, transmission of the beacon, the probe request, the probe response, etc. is performed by the packet transmitting unit 204. Note that the beacon, the probe request, and the probe response each include information about the apparatus that transmits the packets.

When the automatic setting process starts in response to pressing of the setting button 106 by a user, the packet transmitting unit adds information (IE (Information Element)) to the beacon, the probe request, and the probe response to indicate that the automatic setting process is being performed.

A network control unit 205 is configured to control connecting to a network. More specifically, for example, a process of connecting to a wireless LAN ad-hoc network is performed by the network control unit 205.

An encryption key control unit 206 controls exchanging (sharing) of a WPA-PSK key and setting of a WPA-None key. An encryption key storage unit 207 is capable of storing a predetermined number of encryption keys. More specifically, the encryption key storage unit 207 stores a pairwise key and a group key shared via a WPA-PSK key exchange process and/or an encryption key used in WPA-None communication. The encryption key storage unit 207 is capable of storing at least one encryption key for unicast and also at least one encryption key for multicast or the broadcast.

When the communication apparatus operates as an apparatus that receives communication parameters (hereinafter referred to simply as a receiving apparatus), a communication parameter receiving unit 208 in the communication parameter automatic setting block 202 receives the communication parameters transmitted from another communication apparatus. In a case where the communication apparatus operates as an apparatus that provides communication parameters (hereinafter referred to simply as a providing apparatus), a communication parameter providing unit 209 provides the communication parameters to a communication apparatus with which to communicate. An automatic setting unit 210 controls various protocols in the automatic setting process. Note that the automatic setting process is performed under the control of an automatic setting unit 210. The automatic setting unit 210 determines whether the time elapsed since the automatic setting process started has reached a maximum time allowed for the setting process. If it is determined that the elapsed time has reached the maximum allowable time, the automatic setting unit 210 terminates the automatic setting process.

A communication parameter storage unit 211 stores communication parameters provided by the providing apparatus or communication parameters provided to the receiving apparatus. In the present embodiment, if communication parameters are provided from another apparatus, the provided communication parameters are stored as already-set parameters in the communication parameter storage unit 211. When communication parameters are provided to another apparatus, these communication parameters are also stored as already-set parameters in the communication parameter storage unit 211. The already-set parameters stored in the communication parameter storage unit 211 may be discarded when the communication via the network using the already-set parameters is ended. Alternatively, the already-set parameters may be deleted from the communication parameter storage unit 211 when power of the apparatus is turned off.

Note that all functional blocks have mutual relationships with each other in terms of software or hardware. Note that the functional block configuration described above is merely one of examples. For example, some functional blocks may be combined together into a single functional block, or conversely one of the functional blocks may be divided into a plurality of functional blocks.

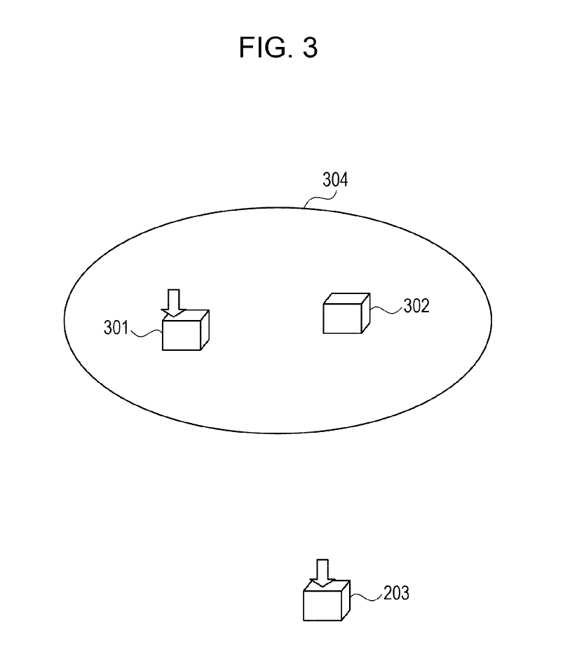

FIG. 3 illustrates a network configuration according to the present embodiment. As shown in FIG. 3, the network system includes a communication apparatus A 301 (hereinafter referred to as an apparatus A), a communication apparatus B 302 (hereinafter referred to as an apparatus B), a communication apparatus C 303 (hereinafter referred to as an apparatus C), and an ad-hoc network A 304 (hereinafter referred to as a network A). Each of all these apparatuses has a configuration similar to that described above with reference to FIGS. 1 and 2. In the present embodiment, it is assumed by way of example that first, the apparatus A and the apparatus B perform an automatic setting process for ad-hoc communication and configures the network A using communication parameters shared by the apparatus A and the apparatus B. Thereafter, the apparatus A and the apparatus C further perform an automatic setting process to make the apparatus C be a member of the network A.

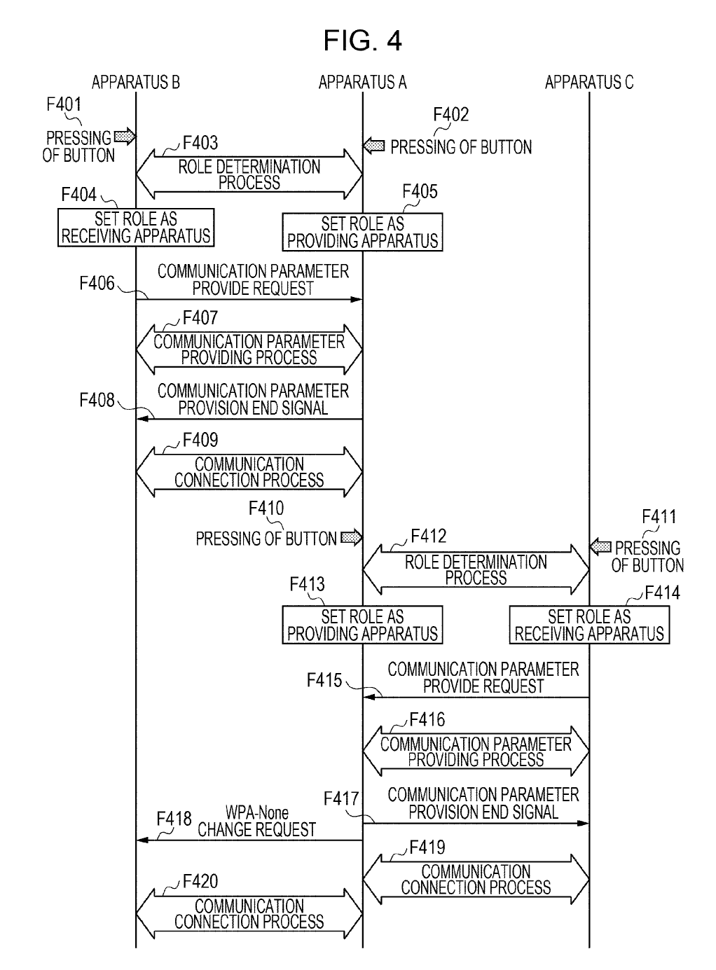

FIG. 4 illustrates a sequence of processes performed by the apparatus A, the apparatus B, and the apparatus C according to the present embodiment. First, to set communication parameters shared by the apparatus A and the apparatus B, a user presses the setting button 106 of the apparatus A and the setting button 106 of the apparatus B (F401 and F402).

In response to the pressing of the setting buttons 106, the apparatus A and the apparatus B start the automatic setting process to establish a network. The apparatus A and the apparatus B detect each other by transmitting a search signal from the packet transmitting unit 204 and receiving a search response signal by the packet receiving unit 203, and then perform a role determination process to determine which apparatus is to function as a communication parameter providing apparatus and which apparatus is to function as a communication parameter receiving apparatus (F403). The determination as to the assignment of roles to the respective apparatuses may be performed, for example, such that an apparatus that first starts the automatic setting process is assigned as the providing apparatus or such that an apparatus designated in advance by a user is assigned as the providing apparatus.

In this specific example, it is assumed that the apparatus A is assigned as the providing apparatus (F404), while the apparatus B is assigned as the receiving apparatus (F405).

The apparatus B assigned as the receiving apparatus participates in the network A established by the apparatus A functioning as the providing apparatus. At this stage of the process, a common encryption key is not yet set between the apparatus A and the apparatus B, and thus encrypted communication of data is not possible yet.

The apparatus B transmits a communication parameter provision request to the apparatus A (F406). Upon receiving the communication parameter provision request, the apparatus A performs a communication parameter providing process in cooperation with the apparatus B that issued the communication parameter provision request according to a predetermined protocol (F407). The contents of the communication parameters provided from the apparatus A to the apparatus B are described in detail below.

The communication parameters provided include the SSID, the authentication method, the encryption method, the encryption key information, etc. Examples of authentication methods are WPA-PSK, WPA-None, etc. Examples of encryption methods include WEP, TKIP, CCMP, etc. Note that WEP stands for Wired Equivalent Privacy and TKIP stands for Temporal Key Integrity Protocol. CCMP stands for counter mode with cipher block chaining/message authentication code. The encryption key information is information associated with an encryption key used in encrypting packets. The encryption key information varies depending on the authentication method.

First, the encryption key information is described below for a case in which WPA-PSK is used as the authentication method. In WPA-PSK, an encryption key to be used in encryption of packets is exchanged (shared) using a PSK (Pre-Shared-Key) that is a common key shared in advance by two apparatuses. More specifically, an apparatus having a greater MAC (Media Access Control) address operates as an authenticator while the other apparatus operates as a supplicant, and four-way handshake and group key handshake are performed between the two apparatuses. In the four-way handshake, random numbers are generated by both the authenticator and the supplicant, and transmitted and received by each other. Based on the random numbers and the PSK, encryption keys (pairwise keys) for unicast packets are generated in each session. In the group key handshake, an encryption key (group key) for multicast packets or broadcast packets is encrypted using the pairwise key and transmitted from the authenticator to the supplicant. In the case where WPA-PSK is used, if communication parameters provided from the providing apparatus specify WPA-PSK as the authentication method, information specified as the encryption key information is employed as the pre-shared key (PSK). In WPA-PSK, as described above, encrypted communication is performed using an encryption key that varies depending on a communication apparatus with which to communicate on the network.

Next, the encryption key information is described for the case where WPA-None is used as the authentication method. In WPA-None, all communication apparatuses participating in the network use the same common encryption key in encrypted communication. That is, four-way handshake and group key handshake are not performed, and the same encryption key is used in packet communication regardless of whether the communication is for unicast, multicast, or broadcast. In the case where communication parameters provided from the providing apparatus specify WPA-None as the authentication method, information specified as the encryption key information is directly used as the encryption key. More detailed information about WPA-PSK and WPA-None may be found, for example, in “Wi-Fi Protected Access Enhanced Security Implementation Based on IEEE P802.11i standard” (http://www.wi-fi.org/register.php?file=wp_State of Wi-Fi_Security_{—}090911.pdf).

As described above, in WPA-None, unlike WPA-PSK in which the encryption key is different for each communication apparatus with which to communicate on the network, the same common encryption key is used by all apparatuses on the network. Therefore, WPA-PSK provides higher security than WPA-None. However, in WPA-PSK, the number of encryption keys that have to be stored increases with the number of communication apparatuses on the network.

Referring again to FIG. 4, at the processing stage of F407, the apparatus A has not yet provided communication parameters to another apparatus, and the encryption key storage unit 207 has a storage space available to store further encryption keys. Therefore, the apparatus A provides, to the apparatus B, communication parameters including encryption key information (hereinafter referred to as first encryption key information) for WPA-None and encryption key information (hereinafter referred to as second encryption key information) for WPA-PSK.

If the communication parameter providing process is ended, the apparatus A sends a communication parameter provision end notification to the apparatus B. (F408).

If the apparatus B receives the communication parameter provision end notification, the apparatus B performs a communication connection process together with the apparatus A according to the communication parameters received from the apparatus A (F409). In this specific case, the communication connection process is performed using WPA-PSK. More specifically, the four-way handshake and the group key handshake described above are performed using the provided second encryption key information, and a wireless connection is established using then encryption key shared by the apparatus A and the apparatus B. Thus, the apparatus A and the apparatus B become possible to perform encrypted communication of data via the network A.

Subsequently, to make the apparatus C be a member of the network A, the user presses the setting buttons 106 of the apparatus A and the apparatus C (F410 and F411).

In response to the pressing of the setting buttons 106, the apparatus A and the apparatus C starts an automatic setting process to determine which apparatus is to function as a communication parameter providing apparatus and which apparatus is to function as a receiving apparatus (F412). In this example, it is assumed that the apparatus A, which is already connected to the network A, is determined to function as the providing apparatus (F413), while the apparatus C is determined to function as the receiving apparatus (F414).

The apparatus C determined to function as the receiving apparatus transmits a communication parameter provision request to the apparatus A determined to function as the providing apparatus (F415). On receiving the communication parameter provision request, the apparatus A performs a communication parameter providing process together with the apparatus C, which is the issuer of the request for communication parameters, according to a particular protocol (F416).

In this specific example, it is assumed that the number of encryption keys stored in the encryption key storage unit 207 of the apparatus A has already reached the maximum number of encryption keys allowed to be stored. Therefore, the apparatus A determines that it is not allowed to make a further communication connection using WPA-PSK, and the apparatus A provides communication parameters including the first encryption key information for WPA-None to the apparatus C.

If the communication parameter providing process is ended, the apparatus A transits a communication parameter provision end notification to the apparatus C (F417). Thus, it will become possible for the apparatus C to perform encrypted communication with the apparatus A by using the provided first encryption key information directly as the encryption key. However, the encryption key is different from the encryption key used by the apparatus B in the encrypted communication with the apparatus A, and thus it is not allowed to perform encrypted communication between the apparatus B and the apparatus C.

To make it possible to perform encrypted communication between the apparatus B and the apparatus C, the apparatus A transmits a change notification to the apparatus B to request the apparatus B to change the authentication method into WPA-None (F418).

On receiving the communication parameter provision end notification, the apparatus C performs a process to establish a communication connection with the apparatus A using the communication parameters received from the apparatus A (F419). As a result, it becomes possible to perform encrypted communication of data between the apparatus C and the apparatus A.

On receiving the notification of the change of the authentication method into WPA-None, the apparatus B again performs the communication connection process together with the apparatus A using the first encryption key information included in the communication parameters received in step F407 (F420). As a result, it becomes possible to perform encrypted communication of data between the apparatus B and the apparatus C.

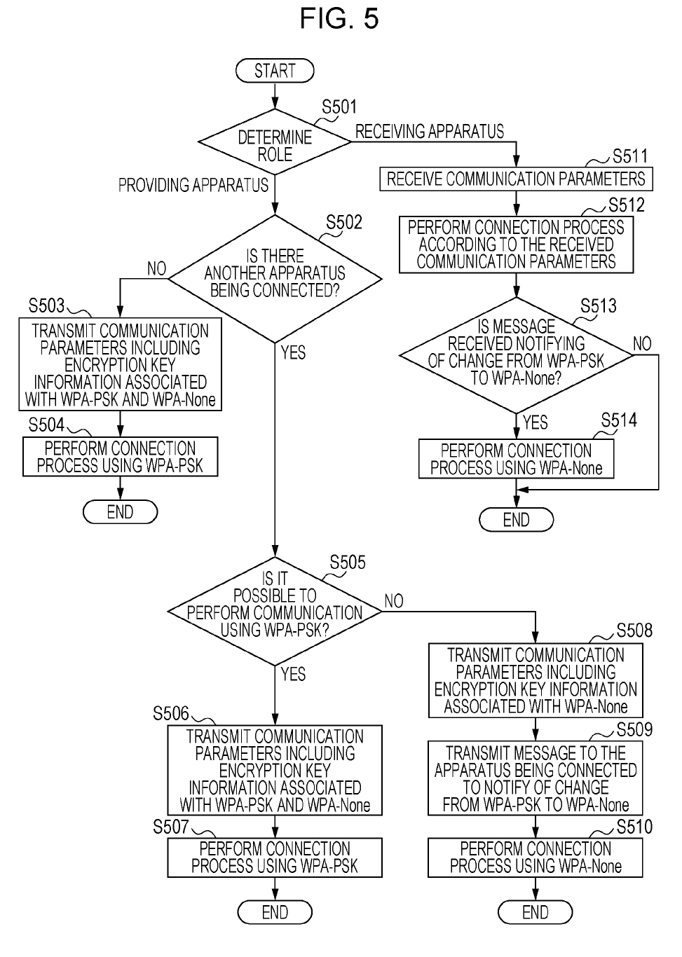

FIG. 5 is a flow chart illustrating a process performed by respective communication apparatuses after the automatic setting process is started.

After the automatic setting process is started, a communication apparatus determines whether the communication apparatus is to function as a communication parameter providing apparatus or a receiving apparatus (S501).

In a case where it is determined that the communication apparatus is to function as the providing apparatus, if the communication apparatus receives a communication parameter provision request from a receiving apparatus, the providing apparatus checks whether there is another communication apparatus on the same network (S502). The checking may be performed, for example, by transmitting a probe request and making a determination based on a probe response received as a response to the probe request as to whether there is another communication apparatus on the same network. Alternatively, the checking may be performed as follows. First, it is checked whether there are already-set parameters stored in the communication parameter storage unit 211. If it turns out that there are already-set parameters stored in the communication parameter storage unit 211, then it is determined that there is another communication apparatus on the same network.

In a case where it is determined that there is no other communication apparatus on the network, communication parameters including first encryption key information for WPA-None and second encryption key information for WPA-PSK are transmitted to the receiving apparatus that issued the request for communication parameters (S503).

After the communication parameters are provided, the communication apparatus performs a communication connection process together with the receiving apparatus using the second encryption key information for WPA-PSK. More specifically, four-way handshake and group key handshake are performed to share a pairwise key and a group key with the receiving apparatus (S504). The communication apparatus stores the pairwise key and the group key shared with the receiving apparatus in the encryption key storage unit 207.

On the other hand, in a case where the checking in step 5502 indicates that there is another communication apparatus on the same network, a determination is made as to where the communication apparatus is capable of establishing a connection using WPA-PSK (S505). More specifically, the determination is made by checking whether the encryption key storage unit 207 of the communication apparatus has a storage space available to store further encryption keys. That is, it is determined whether the number of encryption keys stored in the encryption key storage unit 207 has already reached the maximum number of encryption keys allowed to be stored in the encryption key storage unit 207.

In a case where it is determined in step 5505 that the communication apparatus is capable of making a connection with the receiving apparatus using WPA-PSK, communication parameters including first encryption key information for WPA-None and second encryption key information for WPA-PSK are transmitted (S506).

After the communication parameters are provided, the communication apparatus performs a communication connection process using the second encryption key for WPA-PSK in cooperation with the receiving apparatus (S507).

On the other hand, in a case where it is determined in step S505 that the communication apparatus is not capable of making a connection with the receiving apparatus using WPA-PSK, the communication apparatus transmits communication parameters including the first encryption key information for WPA-None to the receiving apparatus (S508).

After the communication parameters are provided, the communication apparatus transmits a change notification to other communication apparatuses with which communication is being performed to notify that the authentication method is to be changed from WPA-PSK to WPA-None (S509). Thereafter, a connection process using WPA-None is performed among the communication apparatus, the apparatus to which the communication parameters were provided in step S508, and the apparatus to which the authentication method change notification was sent in step S509 (S510). The first encryption key information is stored as the encryption key to be used in encrypting data in the encryption key storage unit 207.

In a case where it is determined in step S501 that the communication apparatus is to function as the receiving apparatus, the communication apparatus requests the apparatus assigned as the providing apparatus to provide communication parameters. In response, the providing apparatus provides communication parameters to the communication apparatus (S511). In accordance with the provided communication parameters, the communication apparatus performs a connection process together with the providing apparatus (S512). In a case where the provided communication parameters include information specifying WPA-PSK as the authentication method, the connection process is performed using the second encryption key information corresponding to the specified authentication method, i.e., WPA-PSK. More specifically, in this case, four-way handshake and group key handshake are performed. The communication apparatus stores in the encryption key storage unit 207 the pairwise key and the group key that has been shared with the providing apparatus via the four-way handshake and the group key handshake. In a case where in addition to the providing apparatus, there is another apparatus that is already connected to the network, four-way handshake and group key handshake with this apparatus are also performed. This ensures high security in encrypted communication among all apparatuses on the network.

On the other hand, in a case where the provided communication parameters do not include information specifying WPA-PSK as the authentication method but WPA-None is specified, the connection process is performed using the first encryption key information corresponding to WPA-None.

Thereafter, if a notification of a change of the authentication method into WPA-PSK is received (S513), the communication apparatus again performs the connection process using the first encryption key information included in the communication parameters received in step S511 (S514).

In the present embodiment, as described above, providing of communication parameters is selectively performed depending on the storage state of encryption keys in the communication apparatus such that both the first encryption key information for WPA-None and the second encryption key information for WPA-PSK are provided to another communication apparatus, or only the first encryption key information is provided.

In a case where the encryption key storage unit 207 has a storage space available to store further encryption keys, both the first encryption key information and the second encryption key information are provided, and communication is performed using WPA-PSK as the authentication method according to the second encryption key information. This makes it possible to use different encryption keys depending on the apparatus with which to communicate, which ensures high security in communication. Providing of the first encryption key information together with the second encryption key information makes it possible to quickly change the authentication method and restart communication when the authentication method is changed into WPA-None.

On the other hand, in a case where the encryption key storage unit 207 does not have a storage space available to store any more data, only the first encryption key information is provided and communication is performed using WPA-None as the authentication method. As a result, the same encryption key is used in communication by all communication apparatuses on the network, which ensures that encrypted communication with moderate security is possible even in a state in which the number of encryption keys allowed to be stored is limited.

In the case where only the first encryption key information is provided to an apparatus that is to be newly connected to the network, a notification is sent to existing apparatuses that are in connection with the network using WPA-PSK to notify that the authentication method is to be changed into WPA-None. On receiving the notification, the existing apparatuses perform reconnection using WPA-None according to the first encryption key information provided before. This makes it possible to quickly start encrypted communication between the communication apparatus newly connected to the network and communication apparatuses already connected to the network.

In a case where a connection with another communication apparatus via the network is not yet established, the first encryption key information and the second encryption key information are automatically transmitted and a connection is established using WPA-PSK, whereby it becomes possible to quickly start high-security one-to-one communication without having to check the storage state of encryption keys.

### Second Embodiment

In the first embodiment described above, the encryption key information to be included in the communication parameters to be provided and the authentication method are determined only depending on the storage state of encryption keys in the communication apparatus. In a second embodiment described below, in contrast, a storage state of encryption keys stored in another communication apparatus with which to communicate is also taken into account in the determination of communication parameters to be provided to the apparatus with which to communicate.

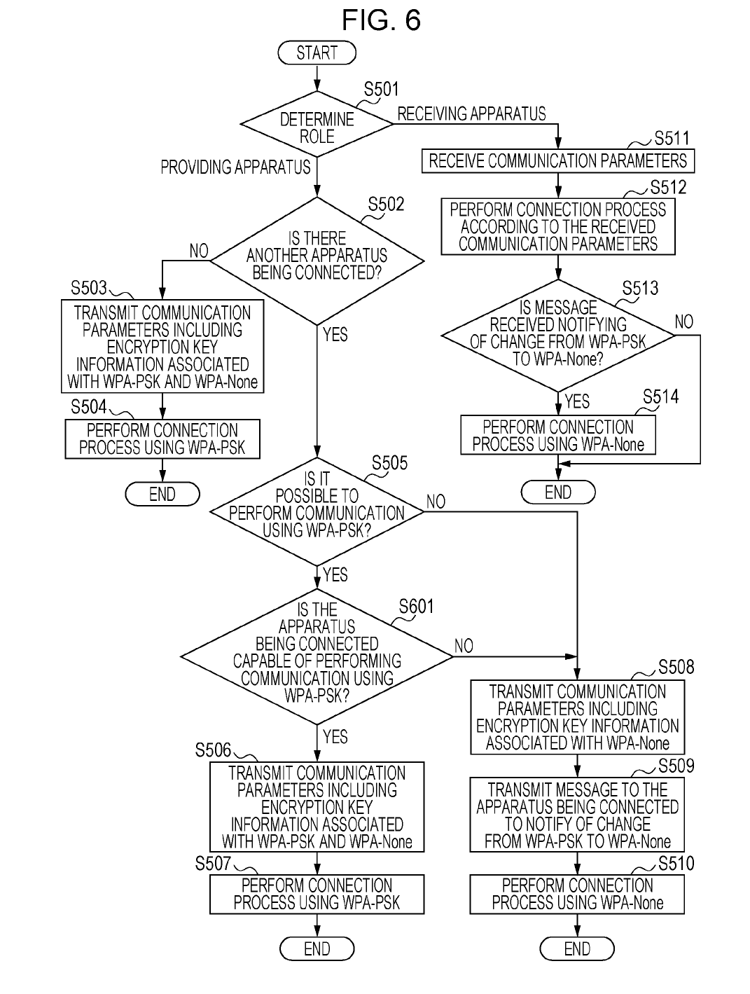

FIG. 6 is a flow chart illustrating a process performed by communication apparatuses according to the present embodiment of the invention. The process is different from that shown in FIG. 5 in that the process includes an additional step 5601. The other steps are similar to those shown in FIG. 5, and thus a description thereof is omitted.

In a case where it is determined in step S505 that the communication apparatus is capable of connecting to the receiving apparatus using WPA-PSK, a further determination is made as to whether other communication apparatuses are capable of connecting by WPA-PSK (S601). More specifically, it is determined whether a receiving apparatus that is to newly participate in the network and apparatuses existing on the network are capable of connecting by WPA-PSK (S601). For example, in a case where the receiving apparatus is capable of storing only one encryption key for unicast and additional one encryption key for multicast or broadcast, if it is tried to perform encrypted communication using WPA-PSK in this situation, the receiving apparatus is capable of storing only an encryption key used in communication with the communication apparatus but the receiving apparatus is not capable of storing a further encryption key. Therefore, the receiving apparatus cannot store an encryption key for use in communication with apparatuses that already exist on the network and thus it is not allowed to perform encrypted communication using WPA-PSK.

Herein it is assumed by way of example that the apparatuses that exist already on the network are capable of storing only one encryption key for unicast and additional one encryption key for multicast or broadcast. In this case, although one-to-one connection using WPA-PSK to the communication apparatus is possible, it is not allowed to store a further encryption key and thus it is not allowed for the apparatuses already existing on the network to store an encryption key for use in communication with an apparatus that is to newly participate in the network. Therefore, in this situation, it is impossible to perform encrypted communication using WPA-PSK.

Thus, in view of the above, the storage state of the encryption key storage unit 207 is checked to determine whether other communication apparatuses existing on the network and the receiving apparatus have a storage space available to store a further encryption key. For example, when each apparatus transmits a communication parameter provision request, the apparatus transmits data indicating the number of encryption keys allowed to be further stored in its encryption key storage unit 207 together with the communication parameter provision request, so that the communication apparatus can determine whether other apparatuses are capable of making a connection using WPA-PSK.

In a case where the result of the determination is that the apparatus with which to communicate is capable of making a connection using WPA-PSK (i.e., the answer to step S601 is YES), the communication apparatus transmits communication parameters including first encryption key information for WPA-None and the second encryption key information for WPA-PSK (S506). On the other hand, in a case where the result of the determination is that the apparatus with which to communicate is not capable of making a connection using WPA-WPS the communication apparatus transmits communication parameters including the first encryption key information for WPA-None (S508).

In the present embodiment of the invention, as described above, the content of encryption key information to be provided and the authentication method to be used are determined based on the storage state of the encryption key storage unit 207 of the apparatus with which the communication apparatus is to communicate as well as the storage state of the encryption key storage unit 207 of the communication apparatus itself. This makes it possible for all communication apparatuses on the network to perform high-security data communication with each other.

In the embodiments described above, it is assumed by way of example that the communication is performed via a wireless LAN according to the IEEE802.11 standard. Alternatively, the communication may be performed via other wireless communication media such as USB, MBOA (Multi Band OFDM Alliance), Bluetooth (registered trademark), UWB, ZigBVee, etc. Note that UWB includes wireless USB, wireless 1394, WINET, etc.

In the embodiments described above, it is assumed by way of example that the communication parameters include the network identifier, the authentication method, the encryption method, and the encryption key information. Note that the communication parameters may include other parameters.

The present invention may be practiced by supplying a storage medium having a software program code stored therein to a system or an apparatus, loading the software program code from the medium onto a computer (or a CPU or a MPU) of the system or the apparatus, and executing the software program on the computer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-283466 filed Dec. 14, 2009, which is hereby incorporated by reference herein in its entirety.

What is claimed is:

1. A communication apparatus comprising:
a storage device configured to store encryption keys used in encrypted communication with another communication apparatus on a network;
a determination device configured to determine whether to provide first encryption key information and second encryption key information based on a storage state of encryption keys stored in the storage device, wherein the first encryption key information is for encrypted communication using a common encryption key among all communication apparatuses on the network and the second encryption key information is for encrypted communication using an encryption key different for each communication apparatus on the network; and
a providing device configured to provide communication parameters including the first encryption key information and the second encryption key information to an apparatus that request for provision of communication parameters based on the determination by the determination device.

2. The communication apparatus according to claim 1, wherein in a case where the communication parameters including the first encryption key information and the second encryption key information are provided in accordance with the result of the determination by the determination device, encrypted communication based on the second encryption key information is performed between the communication apparatus and the apparatus that request for provision of communication parameters.

3. The communication apparatus according to claim 1, further comprising a notification device configured to notify a change to encrypted communication based on the first encryption key information to an apparatus that has already started encrypted communication based on the second encryption key information, in a case where the communication parameters including only the first encryption key information without the second encryption key information are provided in accordance with the result of the determination by the determination device.

4. The communication apparatus according to claim 1, further comprising:
a checking device configured to check whether there is another communication apparatus already existing on the network,
wherein in a case where checking performed by the checking device indicates that there is another communication apparatus already existing on the network, the determination device makes the determination based on the storage state of the encryption keys.

5. The communication apparatus according to claim 4, wherein in a case where checking performed by the checking device indicates that there is no other communication apparatus already existing on the network, the providing device provides the communication parameters including the first encryption key information and the second encryption key information to the apparatus that request for provision of communication parameters.

6. The communication apparatus according to claim 1, wherein the determination device determines whether to provide the first encryption key information and the second encryption key information, based on the storage state of encryption keys stored in the storage device and a storage state of encryption keys in the apparatus that request for provision of communication parameters.

7. The communication apparatus according to claim 1, wherein the determination device determines whether to provide the first encryption key information and the second encryption key information, based on the storage state of the encryption keys stored in the storage device and a storage state of encryption keys in another communication apparatus already connected to the network.

8. The communication apparatus according to claim 1, wherein the determination device determines the storage state of the encryption keys based on the number of encryption keys allowed to be stored in the storage device.

9. A communication apparatus comprising:
a communication device configured to perform first encrypted communication and second encrypted communication, wherein the first encrypted communication is based on first encryption key information using a common encryption key among all communication apparatuses on a network and the second encrypted communication is based on second encryption key information using an encryption key that is different for each communication apparatus on the network;
a first determination device configured to determine whether at least the communication apparatus is capable of performing the second encrypted communication with a first communication apparatus that is already in a state in which the second encrypted communication is possible and with a second communication apparatus to which communication parameters are to be provided by the communication apparatus; and
a providing device configured to provide the second encryption key information to the second communication apparatus based on the determination by the first determination device.

10. The communication apparatus according to claim 9, further comprising:
a second determination device configured to determine whether the second communication apparatus is capable of performing the second encrypted communication with the first communication apparatus even in a state in which the communication apparatus performs the second encrypted communication with the second communication apparatus,
wherein depending on the determination by the first determination device and the determination by the second determination device, the providing device provides the second encryption key information to the second communication apparatus.

11. The communication apparatus according to claim 9, further comprising:
a second determination device configured to determine whether the first communication apparatus is also capable of performing the second encrypted communication with the second communication apparatus even in a state in which the communication apparatus performs the second encrypted communication with the second communication apparatus,
wherein depending on the determination by the first determination device and the determination by the second determination device, the providing device provides the second encryption key information to the second communication apparatus.

12. A method of controlling a communication apparatus including a storage device configured to store encryption keys used in encrypted communication with another communication apparatus on a network, comprising:
determining whether to provide first encryption key information and second encryption key information based on a storage state of encryption keys stored in the storage device, wherein the first encryption key information is for encrypted communication using a common encryption key among all communication apparatuses on the network and the second encryption key information is for encrypted communication using an encryption key different for each communication apparatus on the network; and
providing communication parameters including the first encryption key information and the second encryption key information to an apparatus that request for provision of communication parameters based on the determination.

13. A method of controlling a communication apparatus configured to perform first encrypted communication and second encrypted communication, wherein the first encrypted communication is based on first encryption key information using a common encryption key among all communication apparatuses on a network and the second encrypted communication is based on second encryption key information using an encryption key that is different for each communication apparatus on the network, the method comprising:
in a case where the communication apparatus is capable of performing the second encrypted communication with a first communication apparatus, determining whether the communication apparatus is capable of performing the second encrypted communication to a second communication apparatus to which communication parameters are to be provided by the communication apparatus; and
depending on the determination, providing the second encryption key information to the second communication apparatus.

14. A storage medium storing a program configured to control a communication apparatus including a storage device to store encryption keys used in encrypted communication with another communication apparatus on a network, the program comprising:
determining whether to provide first encryption key information and second encryption key information based on a storage state of encryption keys stored in the storage device, wherein the first encryption key information is for encrypted communication using a common encryption key among all communication apparatuses on the network and the second encryption key information is for encrypted communication using an encryption key different for each communication apparatus on the network; and
providing communication parameters including the first encryption key information and the second encryption key information to an apparatus that request for provision of communication parameters based on the determination.

15. A storage medium storing a program configured to control a communication apparatus configured to perform first encrypted communication and second encrypted communication, wherein the first encrypted communication is based on first encryption key information using a common encryption key among all communication apparatuses on a network and the second encrypted communication is based on second encryption key information using an encryption key that is different for each communication apparatus on the network, the program comprising:
in a case where the communication apparatus is capable of performing the second encrypted communication with a first communication apparatus, determining whether the communication apparatus is capable of performing the second encrypted communication to a second communication apparatus to which communication parameters are to be provided by the communication apparatus; and
depending on the determination, providing the second encryption key information to the second communication apparatus.
